(19) United States
(12) Patent Application Publication
(10) Pub. No.: US 2022/0237221 A1
(43) Pub. Date: Jul. 28, 2022

(54) SYSTEM AND METHOD FOR IDENTIFYING AND EXTRACTING INFORMATION

(71) Applicant: Element Standard, Inc., Orlando, FL (US)

(72) Inventors: Jaron Luttich, Orlando, FL (US); Ryan Hudson, Orlando, FL (US)

(21) Appl. No.: 17/581,496

(22) Filed: Jan. 21, 2022

Related U.S. Application Data
(60) Provisional application No. 63/140,376, filed on Jan. 22, 2021.

(51) Int. Cl. G06F 16/35; G06F 16/383; G06F 16/34

(52) U.S. Cl. CPC G06F 16/358; G06F 16/345; G06F 16/383

(57) ABSTRACT

The invention encompasses a computer system that, using a structure and design solution, identifies and extracts litigation case documents and particular versions thereof within the case or document management system used for the litigation(s). The computer system includes a communication network linked to one or more of the sources and a computer server in communication with the communication network. The computer server is configured to receive electronic documents from the sources via the communication network.

### CROSS-REFERENCE TO RELATED APPLICATIONS

This application claims the benefit of U.S. provisional patent application No. 63/140,376, which was filed on Jan. 22, 2021, and is incorporated herein by reference in its entirety.

### FIELD OF THE INVENTION

The invention encompasses a computer system that, using a structure and design solution, identifies and extracts litigation case documents and particular versions thereof within the case or document management system used for the litigation(s). The computer system includes a communication network linked to one or more of the sources and a computer server in communication with the communication network. The computer server is configured to receive electronic documents from the sources via the communication network. The computer server has memory and a processor, the memory including processor executable instructions stored in the memory and executable by the processor. The instructions comprise data collection instructions, topic modeling instructions including instructions for weighing and instructions for indicating a distribution for identified issues within each of the retrieved documents, issue assignment instructions, instructions for determining, and instructions for management.

### BACKGROUND OF THE INVENTION

Collections of data are becoming commonplace in the legal industry. However, these large stores of data are useless without the employment of effective techniques for uncovering meaningful, actionable insights out of the multitude of available information.

As trends intensify and issues become more volatile, the time that managers have to react to these issues diminishes, and their available options dwindle quickly. There is a need for systems and methods which address this problem to maximize control while limiting losses and missed opportunities.

If the process of sifting through mountains of data to select and prioritize issues for each report was done solely by hand, it would 1) take an inordinate amount of time, 2) have a high potential for error, and 3) undoubtedly introduce some measure of subjectivity.

As these drawbacks are quite significant, there is a need for a solution that will perform the task of issue discovery and prioritization in a consistent, repeatable fashion. A separately filed patent application, directed to the litigation cartography system and method describes such a solution, which permits voluminous data from multiple litigations and among multiple counsel to be consolidated without introducing error in the issue discovery and prioritization process.

The instant invention is based on the litigation cartography system and method and addresses the need to identify and extract a specific version of a litigation case document where there may be multiple drafts and iterations of that document within the case or document management system(s) being used for the litigation(s). For example, an exemplary application of the instant invention provides a system and method for storing, organizing, retrieving, and sharing case documents that permits the rapid and definitive identification of, and extraction of, the truly “final” version of a particular document created or exchanged during litigation.

### SUMMARY OF THE INVENTION

The present invention is based on litigation cartography which encompasses a system and method for achieving the following:

The system and method provides an architecture rooted in how litigation works in maximally efficient manner. When instant litigation taxonomy is deployed within a document management, eDiscovery, or case management software, the utility of the technical tool can be matched, for the first time, to workflows that litigators already use. Through the application of these system and method tools, in-house teams and law firms alike can better leverage the data they create and manage for planning purposes and for assessing the value of the litigation services being provided. The system and tools further make it easier for litigators even at different firms or companies to consolidate, share, and leverage their collective data.

The system and method for litigation cartography generates litigation billing codes that can be used to form the basis for a legal services delivery measurement and analytics solution and, when linked to a specified activity, provide the opportunity for narrative-free billing and timekeeping. By creating “good data,” litigation cartography makes real the possibility of “moneyball” analytics for practitioners. In short, “good” data leads to actionable data, which in turn leads to data-driven decisions making and better risk management.

The system and method developed has a comprehensive, stages/parts/elements approach to train and teach litigation to lawyers, paralegals, and clients—or anyone else. Moreover, this tool can be used to bridge the gap between training (e.g., law school) and competency in a way that no other program can or has.

In various embodiments, the invention encompasses a computer-implemented method of managing file sharing links, in various embodiment, comprises: (1) in response to receiving a request to share a file set, generating a file set sharing link, wherein the file set sharing link is configured to provide a link recipient with at least access to a linked file set; (2) capturing information associated with the generated file set sharing link; (3) capturing information associated with the link recipient; (4) associating the link recipient information with the captured information associated with the file set sharing link; and (5) in response to a request to view the information associated with the generated file set sharing link, displaying a list of file set sharing links associated with the requester, wherein the list of file set sharing links contains information about the generated file set sharing link.

In other embodiments, the invention encompasses a computer system, in accordance with various embodiments, comprises one or more processors, and memory. The one or more processors is adapted to, within the context of a synched file management system: (1) store information regarding a plurality of file sharing links associated with a user, wherein the file sharing links provide access to files that are stored in the memory; and (2) selectively display a listing of the one or more file sharing links to the user.

The system and method for litigation cartography was developed by using proven design methods and UI/UX designers to clarify and organize the litigation process and to complement existing litigation technologies. Borrowing from proven concepts founded in Information Design theory, this method works by first disaggregating the litigation process into discrete components and then mapping those components into 6 stages (e.g., Pleadings), 21 parts (e.g., The Plaintiff's Complaint), and 100 elements (e.g., Service of Process). This breakthrough methodology (1) makes litigation teachable and trackable at every procedural point—enabling it to be measured, analyzed, and billed with this standard of precision—and (2) provides the foundation for communication, both for professionals and their technology, upon which today's collaborative solutions can be built and to which existing tools can be aligned.

In its broadest embodiments, the invention of the present application encompasses a system and method to store and share litigation “case documents,” such as documents that are filed with the court (e.g., motions or pleadings), exchanged with the other side (e.g., interrogatories or correspondence), or consist of transcripts from depositions or hearings or other official proceedings. Because of the volume of case documents created and exchanged even in the most modest of cases, let alone in a series of such cases, finding a particular case document can at times become a time consuming (and expensive) task, however. Furthermore, even once a search has revealed the needed case document, uncertainty might remain as to whether the retrieved document is in fact the version of the document that was the object of the search (such as the actual “final” version created or exchanged). This is especially true when the needed materials are co-mingled with other work product and draft materials within the case or document management systems and email folders or, for example, when the desired version of the document resides solely with a colleague or co-counsel.

One embodiment of the invention is a system and method to store and share case documents and identify final versions of such documents. The exemplary final version system supplements current case or document storage systems and relies on a standard structure that intuitively aligns every case document with how litigators practice. With the final version system, litigators on any sized case can:

find a specific case document within seconds;

collaboratively share documents within a law firm, with co-counsel, or with a client; and

know that they have found the true final, final version of the needed case document.

Litigation cartography provides the organizing principle and structural backbone for the final version system, which is a SaaS solution for litigators to store, retrieve, and share final versions of their work product via the storage structure provided by litigation cartography.

By employing the final version system and method, practitioners can rapidly and confidently find the final version of pleadings, filings, and discovery materials through the use of precise, searchable tags that are unique to the system and method. The use of the final version system removes any uncertainty that the practitioner might have regarding whether a particular document is in draft or is, in fact, in final form. This facilitates the sharing of important case information among team members, co-counsel, and clients. It also facilitates knowledge management by identifying materials that have been organized pursuant to the litigation cartography method and marked as firm approved and in final form.

The final version of the system and method further is a system and method for the practitioner to find and retrieve sought-after case documents. For example, such materials can be located according to when they were entered into the tool through the “Recent” tab (FIG. 4), or can be located by the case in which they are a part (FIG. 5), by client (FIG. 6), and/and by document (FIG. 7), using the document's classification under the litigation cartography method and related “foldering”/tagging of the materials.

In various embodiments, the invention encompasses a computer-implemented system and method that provides interaction between users and a system to allow access to information of a plurality of products or services comprising: storing in at least one non-transitory computer memory, a database containing user information for a plurality of users and instructions pertaining to the users including account information; accessing the at least one computer memory by a computer processor of a server-based knowledge management system that executes instructions and performs steps including: interfacing to the server-based knowledge management system comprising at least one server that allows users to interact with a provider over a plurality of different electronic communication channels using a plurality of different remote user access devices; receiving, using the processor, user requests over a plurality of different inbound electronic access communication channels; using an access identifier processor that determines specific inbound electronic access communication channels corresponding to specific user requests; inputting information regarding said user requests to the server-based knowledge management system servicing multiple different inbound electronic access communication channels; accessing, by the server-based knowledge management system, user profile data corresponding to the user requests from the database being accessed by the server-based knowledge management system; retrieving, using the processor, user preferences based on the user profile data for the requesting user; processing, using the processor, the user requests by the server-based knowledge management system that generates personalized responses in a cross channel environment, at least some of the personalized responses being generated based on context specific content based on the user profile data for the requesting user formatting based on the requesting user's preferences; identifying capabilities and characteristics of the user; and delivering, in response to specific user requests, the responses electronically from the server-based knowledge management system to the users over a plurality of different outbound electronic delivery communication channels, the format and type of responses based on the capabilities and characteristics of the remote user access devices identified, where at least one of the outbound electronic delivery communication channels for the specific user is different from the inbound electronic access communication channels for the specific user, and where the inbound electronic access communication channel, for example, through email, internet, or using a web device.

In embodiments, the knowledge management system services multiple electronic communication channels.

In embodiments, the personalized responses comprise at least some responses being sent over outbound electronic delivery communication channels selected based on inbound electronic access communication channels.

In embodiments, the user profile data for each user indicates, based on the type of inbound electronic access communication channel used for a request, what outbound electronic delivery communication channel should be used to deliver the response.

In embodiments, the knowledge management system includes a plurality of user profiles defining different mappings of delivery communication channels to access communication channels for various users, such that the mappings for delivery communication channels are user-specific.

In embodiments, the responses being personalized comprise the knowledge management system generating responses that include additional information on unsolicited offers for information or services.

In embodiments, the personalized responses include additional information besides that requested comprising alerts that users have subscribed to.

In embodiments, the personalized responses include additional information besides that requested comprising general information and specific information retrieved from folders for a plurality of users.

In embodiments, the personalized responses include additional information besides that requested comprising one or more value propositions selected for a plurality of users.

In embodiments, the knowledge management system includes a engine processor; and where the responses comprise the management system generating responses including additional information besides that requested; where a plurality of potential propositions for specific users are inputted to the engine processor; and where the engine processor processes the potential propositions that selects one or more which are delivered to users in response to user requests.

In embodiments, the access identifier processor is a channel-device identifier.

In embodiments, the responses are personalized based on past interactions and current interactions with the knowledge management system.

In embodiments, the response are personalized based on past interactions and current interactions including click-stream data, and where a series of responses are delivered in response to click-stream data acquired in a single session.

### BRIEF DESCRIPTION OF THE DRAWINGS

FIG. 1 illustrates organizational materials for mapping the chronology and categories of a case.

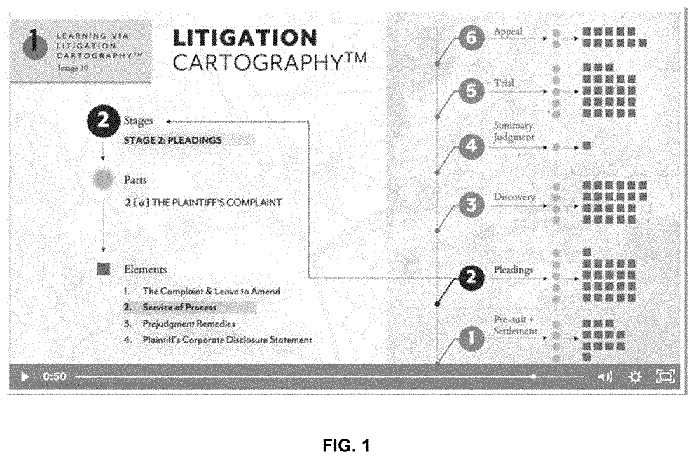

FIG. 2 illustrates organizational materials for mapping the chronology and categories of a case.

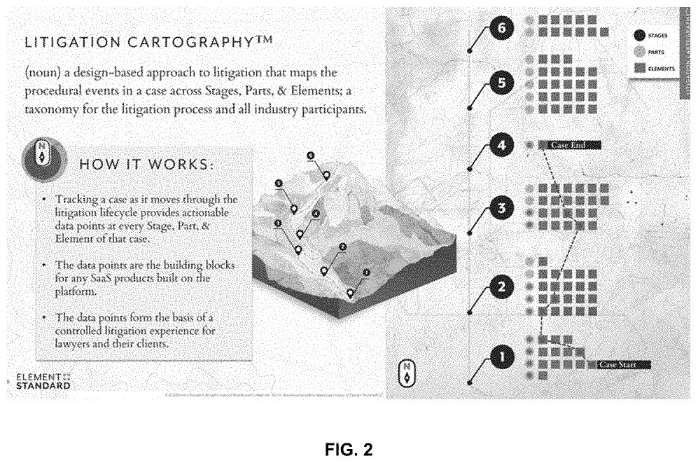

FIG. 3 illustrates exemplary knowledge management system by identifying materials that have been organized pursuant to the cartography method and marked as firm approved and in final form.

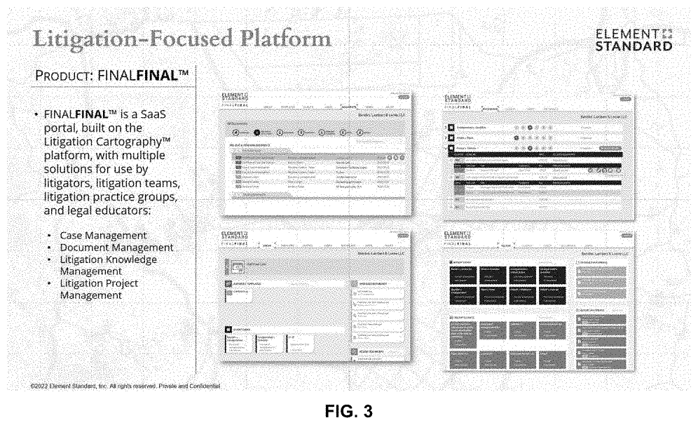

FIG. 4 illustrates an exemplary embodiment illustrating organization of materials.

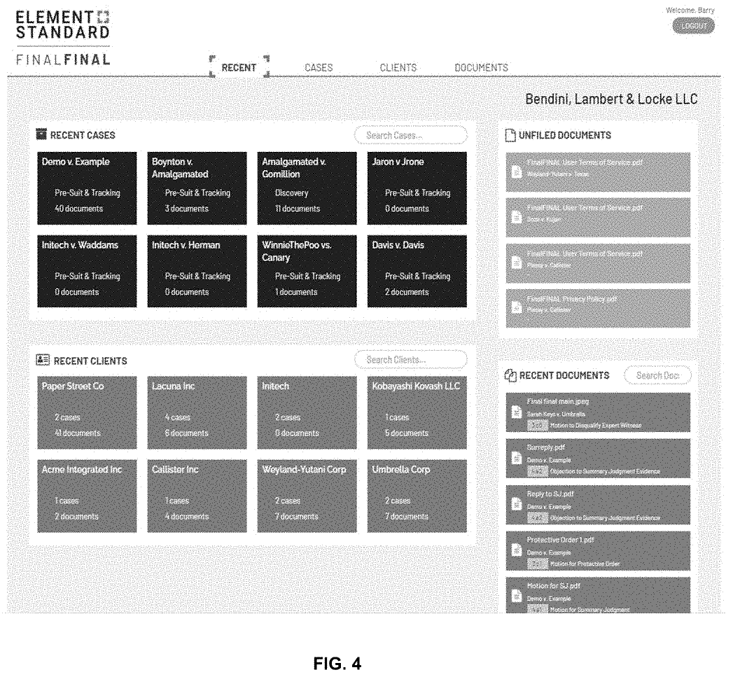

FIG. 5 illustrates an exemplary embodiment illustrating organization by status of case.

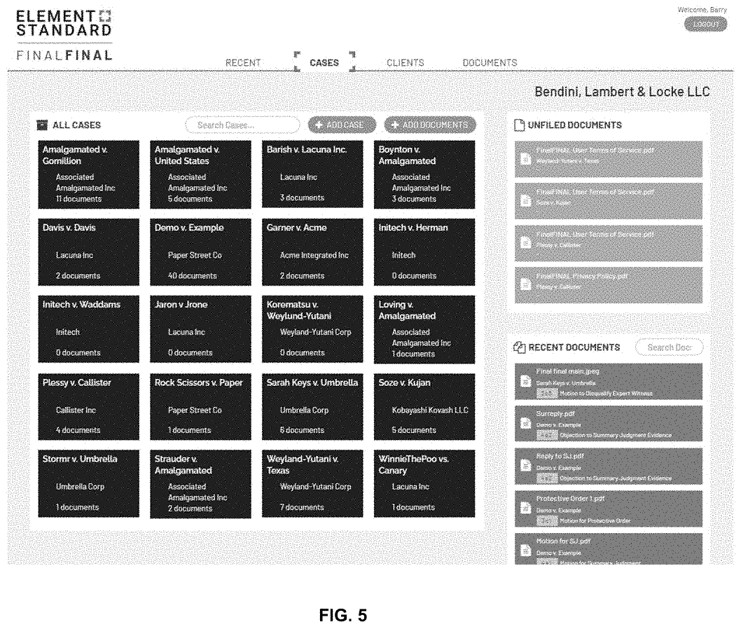

FIG. 6 illustrates an exemplary embodiment illustrating organization by client.

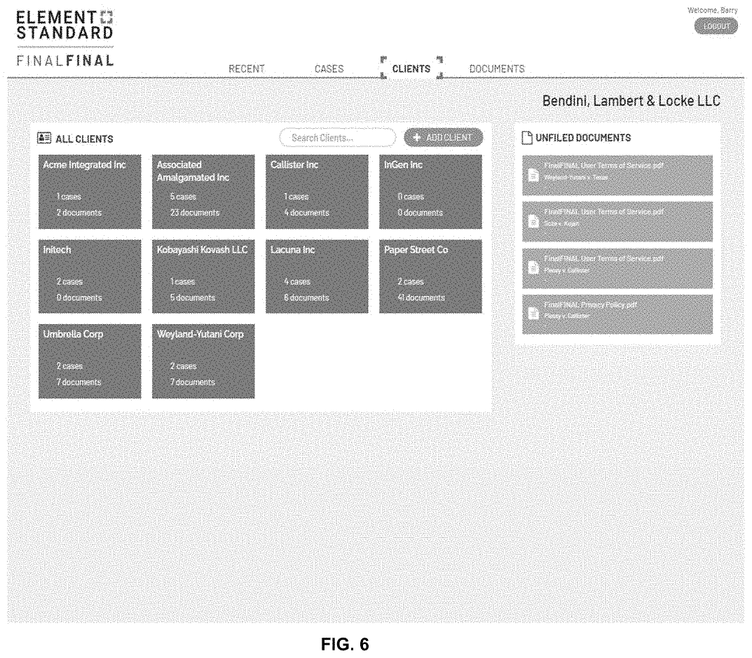

FIG. 7 illustrates an exemplary embodiment illustrating organization by document.

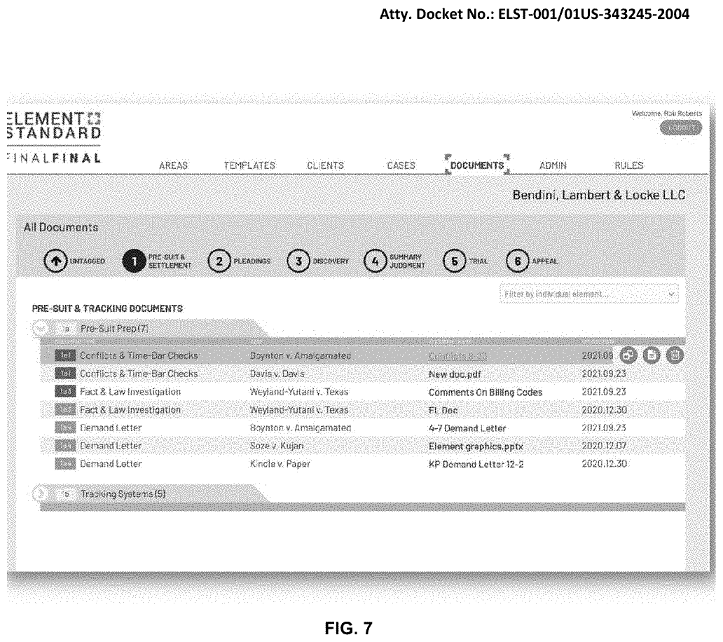

### DETAILED DESCRIPTION OF THE INVENTION

The systems and methods described herein comprise a processor-implemented multi-step analysis designed to start with broad observations, and arrive at the highest-priority strategic actionable insights in a repeatable, automated fashion. In the present invention, the insights at issue include the identification of specific case documents and versions of such documents included in a case or document management system.

The system, according to various embodiments, is adapted to allow users to share files or folders stored on a networked file storage device by: (1) creating a link to the location of the files or folders in the storage device; and (2) sharing the link with other users by sending to such other users a communication containing the created link. The other users may access the files or folders by “clicking” or selecting the link, or by copying the link from the communication of the sending user and pasting it into a browser on their computer.

The invention aims to manage knowledge obtained from user interactions and personalize the information/product/services that are offered to the user as a result of those interactions. The invention utilizes data obtained from past and present interactions to make decisions and manage information/products/services of the user. Further, the invention is directed to systems and methods that manage and organize a taxonomy for the litigation process and all related industry participants and for tracking, managing, storing the information/service/product based upon using all the knowledge, which can be obtained from past and present interactions with the user to provide actionable data points at every stage, part, and element of a project (e.g., a litigation). In various embodiments, the data points are the building blocks for any SaaS products built on the platform. In certain embodiments, the data points form the basis of creating the first unified litigation experience for user. In embodiments, the invention provides a customized platform to the user's preferences, characteristics and interests, and organizes and manages information and/or products that would be suitable to the user.

The invention provides a single, integrated system that allows multiple users to utilize the system and organizes and manages information, thus centralizing knowledge and creating a unique user interaction experience.

The invention aims to integrate within an information/product/service, the various departments of the information/product/service provider so that the various information/product/service within a single framework, for example, a legal framework or even among groups users, can provide a plurality of information/services/products to the user using an integrated approach. For example, taking the example of a litigation service provider, the invention makes information concerning various stages of litigation available to one or more users working on a specific litigation matter so that the legal service provider can organize legal information for that user. Taking another example, a lawyer involved in a litigation may be offered information concerning litigation events or documents that a user may require for a specific timing of the litigation. In this way, the system of the invention allows collaboration and cross-fertilization (cross-application) across different channels of an information/service/product provider.

Presently, in many legal departments that provide multiple services/information, one department providing a particular service/product/information may be totally unaware of prospects known to another department specializing in a different area of that same company or legal department or of knowledge that a user exists in other relationships. The invention, through an integrated system, will allow the user to be more responsive to the litigant's or court's needs. In effect, the invention has the effect of ending what is often called the “silo” mentality, i.e., the compartmentalizing of departments in a company so that one department is unaware of status of information from another department. A user is defined as anyone who uses the system. The invention aims to achieve the above objects by integrating various channels through which users communicate with the information/service/product provider. The various channels may include the internet, but also other channels such as phone lines, offices, e-mail, direct mail and most other channels of communication. Further, the system of the invention allows use of multiple channels. The system allows the user to interact with other users or user to user interaction within a product/service department.

According to the invention, the above described objects are achieved by a system for communicating over at least one communication channel and a provider of information/products/services, the user having a communication device for communication, the system comprising: a system for interfacing with a user; a product/service interface for interfacing with and information/product/service; and a knowledge management system coupled to the product/service interfaces, the knowledge management system comprising a knowledge/management repository storing information concerning the user, the information obtained from interaction with the user including current interactions between the user, documents relevant to the user, and further for storing information concerning a plurality of information/products/services to offer to the user; and a personalization engine for making a decision as to which of the plurality of information/product/services to present to the user over the communication channel based on the stored information in the knowledge/management repository.

In particular embodiments, the system is adapted to keep track of any links generated by, sent by, and/or received by a particular user. The system may display a listing of the links upon request by a user, so that the user may re-use or deactivate the links, or modify attributes of the links. Having a centralized listing of the links may be particularly advantageous in helping a user keep track of the files and folders that they have shared and received.

In certain embodiments, the links may be links to read-only copies of files stored centrally by a document management service, such as the Dropbox service. However, in other embodiments, the links may be links to shared folders, i.e. folders containing files that may be modified by multiple users remotely located from one another.

In embodiments, the invention comprises a method managing products/services between a user communicating over at least one communication channel and a provider of information/products/services, the user having a communication device for communication over the channel with the provider with which the user interfaces with the channel. A system is interfaced with the channel and an information/product/service provider. Information is stored in a knowledge management repository concerning the user, the information obtained from interaction with the user over the channel including current interactions between the user and the knowledge management system. Further, information is stored in the knowledge management repository concerning a plurality of information/products/services to offer to the user. A decision is made as to which of the plurality of information/products/services to present to the user over the communication channel based on the stored information in the knowledge management repository.

In another embodiment, the invention provides a system for a user communicating over at least one communication channel and a provider of information/products/services, the user having a communication device for communication over the channel with the provider, the system comprising: a channel interface for interfacing with the channel; a product/service interface for interfacing with an information/product/service provider; and a knowledge management system coupled to the channel and product/service interfaces. The knowledge management system comprises a knowledge management repository storing information concerning the user, the information obtained from at least one of interaction with the user over the channel including current interactions between the user and the knowledge management system and information obtained about the user from other sources. The knowledge management repository further storing information concerning a plurality of information/products/services to offer to the user for deciding as to which of the plurality of information/product/services to present to the user and for content of the information/product/services provided to the user over the communication channel based on the stored information in the knowledge management repository.

In another embodiment, the invention provides a method for interaction between a user communicating over at least one communication channel and a provider of information/products/services, the user having a communication device for communication over the channel with the provider in which the user is interfaced with the channel. A knowledge management system is interfaced with the channel and an information/product/service provider. Information is stored in a knowledge management repository concerning the user, the information obtained from at least one of interaction with the user over the channel including current interactions between the user and the knowledge management system and information obtained from other sources. Information is further stored in the knowledge management repository concerning a plurality of information/products/services to offer to the user. A decision is made as to which of the plurality of information/product/services to present to the user and for content of the information/product/services provided to the user over the communication channel based on the stored information in the knowledge management repository.

The system of the invention accordingly provides a framework of components, their relationships, functions, and purposes for creating and maintaining a personalized interaction that is constant and can be tailored to any communications channel.

Further, the system of the invention can be used with any interactive communication channel and further is applicable to a wide variety of goods/products/services/information including, without limitation, legal products/services, government products/services, corporate products/services, and information in general. For example, with respect to legal institutions, information such as pleadings, discovery, or documents and files can be stored, organized and tracked. Offerings can be provided to the user in such areas as archives for legal requirements, product fulfillment and user service. For law firms, document organization can be provided and the interaction personalized. For example, for legal requirements or data mining of intellectual property are some examples of offerings which can be provided by the system of the invention. For governmental agencies, forms, deeds, statements and other documents and files etc. may be stored and offerings may be provided with respect to these, for example, personalized data views can be provided. The system of the invention provides convenience, security and efficiency. Corporations can use the invention for documents/file storage, trade materials and/or vault services, for example. These can be used for internal use work flow improvement or order fulfillment.

The systems and methods allow the ability to deliver targeted services and information tailored to the user's preferences, interests and needs. Targeting allows the creation of a user experience which reflects the relationship and the user's requirements, also called “user centric” experience. Furthermore, with respect to interaction via an Internet web site, targeting allows filling “white space” which can be described as the ability to promote an interaction with messages and other components using matching and selection based upon the user's profile, contacts, indications or assumptions derived through analysis, past interactions or contacts and the current interaction. The system is designed to adapt to all touch points or channels and all devices of interaction. Information can be static or dynamic based on a user's explicit/implicit preferences and historic data or dynamic based on real time assessment of the next best step.

The systems and methods are adaptable to all channels, as described above, such channels as the internet, extranet, phone lines, e-mail, automatic teller machines, branch offices, etc.

The present invention provides a means to personalize an interaction via various communication channels between a user of information/goods/services. The invention allows a user to interact so that the user is recognized and the user's needs anticipated. The system allows advising the user and providing access to all information/products/services offered by the provider. Further, the system allows for tailored packages, i.e., non-standard packages. Furthermore, the system allows for continuously gathering, analyzing and distributing information to make the user receive a more rewarding experience. Moreover, the system creates a basis for retaining users, better servicing users, and tailoring solutions based on a result provided by the system.

According to the invention, once a user contacts a communications channel using the system of the invention, the first step is identification and authentication of the user at the start of the session (the security layer). This triggers the collection of a real time, user profile which, created and combined, provides the basis for the delivery of a personalized experience. The same functions and information are made available at each touch point (i.e., through each channel). The actual experience that the user has will be adapted to the user's preferences and the capabilities. A decision engine provides key parameters for the real time assembly of the experience. Other parameters are the capabilities of the touch point and the course of the dialogue, for example, the click stream if communication is over the internet.

A management system is the central coordination point for all user related information. The management system is designed to be an appropriate directory service and repository support and it mediates access to all user related information. Sub-components of the management system provide services such as authentication and authorization, aggregation of profile attributes including user preferences, segmentation and campaign targeting/tracking information for the user, contact information, and outstanding commercial and services issues (“workflow process” status).

Information to be presented to the user is matched with the user profile needs and preferences and delivered at the right time and the right place. Each session will update the user profile, trigger follow-up activity and provide data for user interaction analysis and fine tuning of the user dialogue and the value proposition (offer).

The steps in the process include selection of functions, navigation screens and templates which consider the specifics of the communication channel. News and messages can be provided to the user.

Further, the system personalizes the process by content selection, based on preferences and customization rules. The system provides news and topics to the user using searching and filtering technologies.

Further, so called “white space” in the user display can be filled with propositions, actions, alerts, notifications, etc., decided by rules based on, for example, user preferences or analysis of the user profile.

In addition, the system can predict needs and can propose actions or recommendations based on matching of user profiles and behavior of like-minded people. The system determines next steps based on analysis of the current interaction, obtains feedback and learning to be captured in the user knowledge base and includes a rule oriented data base for application of personalization to thereby personalize information, offers, terms, conditions, and financial advice, etc.

Data Collection

In one embodiment, systems and methods of the disclosure include a data collection subsystem of processor executable instructions to periodically aggregate documents (specifically the case documents associated with a particular litigation or set of litigations) related to the business interests of current and potential clients (i.e., entities) via a communications network of one or more document monitoring portals. In order to achieve the objective of offering ready identification and extraction of particular documents, and versions of such documents, the systems and methods of the disclosure cull and prioritize the full range of documents to form concise, informative reports.

The input to the systems and methods described herein is any sizeable collection of text documents. This collection typically consists of documents from various sources, all targeted toward specific issues of interest. In the present invention, the documents are “case documents,” e.g., any document created or developed as part of the litigation process by any party, such as documents that are filed with the court (e.g., motions or pleadings), exchanged with the other side (e.g., interrogatories or correspondence), or consisting of transcripts from depositions or hearings or other official proceedings. As noted herein, each document, upon retrieval, is annotated automatically using processing systems to identify the document. These annotations, along with the full text, are stored in databases, and are available for each of the steps in the processor-implemented analysis of the systems and methods described herein.

Topic Modeling

The next step after data collection by subsystem in the systems and methods described herein is to classify by an initial topic modeling subsystem of processor executable instructions the multitude of case documents into binned topics of discussion, or issues. In one form, the systems and methods described herein automatically identify all topics, including new, emerging topics in a quick and efficient manner using any collection of documents a user provides so that training data is minimized or not required.

For example, the systems and methods described herein apply text analytics technology to discover the topical structures of documents and classifying those documents into different topical categories. The litigation cartography backbone for the present invention has several advantages over traditional classification techniques. First, no manually-classified training data is needed. Second, litigation cartography is adaptive to topical change. These advantages can be achieved because litigation cartography learns the topical categories from a set of documents directly; no knowledge (or limited knowledge) about the topical categories is required in advance. Third, in litigation cartography, unlike in other techniques, a document can be assigned to specific topical categories.

In systems and methods described herein, each topic discovered represents a document within the targeted dataset stored in databases. Issues are given meaningful labels by an operator via an operator input device by a person with knowledge related to the overall dataset using the semantics of the set of terms with the highest topic-term probabilities for the given topic. As such, contextually off-target topics and issues identified during the labeling analytics are discarded by an operator via the operator input device; additionally, highly-overlapping issues are combined as deemed necessary.

Subtopic Modeling

In some cases, an issue derived from the litigation cartography analytics may be useful in the identification of concise core messages or actionable key insights. In the present invention, the insights at issue include the identification of specific case documents and versions of such documents included in a case or document management system. After such issues are identified by an operator via the operator input device during the topic-labeling analytics, the text from the documents assigned to these issues is collected and re-run through the analysis systematically by a server, issue-by-issue, in order to achieve more granular divisions of topics within these issues. After the more granular “subtopics” are labeled by an operator via the operator input device, off-target subtopics are discarded as before, while contextually relevant subtopics are promoted as independent issues, and added to the complete list of issues discovered. The topic modeling associated generally with litigation cartography may be accomplished by an initial topic modeling subsystem followed by a subtopic modeling subsystem of processor executable instructions. Alternatively, the initial topic modeling and the subtopic modeling may be accomplished by a single topic modeling subsystem and the subtopic modeling subsystem merely redirects topics to topic modeling subsystem for further granular analysis.

Thus, in one form, the topic modeling subsystem of the present system includes the initial topic modeling subsystem and the subtopic modeling subsystem comprising processor executable instructions including initial topic modeling instructions for identifying one or more initial issues in the collection of the retrieved documents according to terms in the retrieved documents, and subtopic modeling instructions for identifying one or more issues in each of the initial issues of the retrieved documents according to terms in the retrieved documents for each initial issue.

Issue Assignment

As described above, the prominence of a topic within a document is defined by an issue assignment subsystem of processor executable instructions using the probabilities in a document-topic probability matrix. The systems and methods described herein move forward by using these probabilities to formally “assign” a discrete number of the most highly-prominent topics represented in each document to the document itself in the following manner:

Thus, in one form, the issue assignment subsystem of processor executable instructions comprises issue assignment instructions for limiting the number of issues formally associated with each of the retrieved documents based on the values in the document-topic probability matrix.

Predictive Issue Ranking

The next step in the analytics is executing a predictive issue ranking subsystem of processor executable instructions to rank-order the assigned issues identified in the topic modeling subsystem and subtopic modeling subsystem and assigned by the issue assignment subsystem. Top-ranked issues will be deemed to be the most significant issues in the current landscape of the business decision-making process.

Ranking is performed by combining several per-issue summary metrics into a single quantitative score for each issue. These per-issue quantitative scores may then be sorted numerically to determine the overall order of significance of the issues.

As can be seen, the present invention is a unique system and method based on the litigation cartography system and method where the goal is to provide efficient and effective means for litigation practitioners to organize, identify, retrieve, and share desired case documents, and a particular version of such case documents, within the case or document management system used for the litigation(s) with case team members, co-counsel, and clients. The final version system and method is an embodiment of the invention that provides the means to organize, identify, retrieve, and share the final version of case documents to such stake holders. By using the final version system and method, search and retrieval times, as well as the costs associated with search and retrieval times, can be significantly reduced and confidence that the retrieved case documents are in fact the final versions of the sought-after materials can be greatly enhanced.

What is claimed:

1. A system comprising: a communication network; a computing device in communication with the communication network, the computing device to receive electronic case documents from electronic media sources via the communication network; the computing device having memory and a processor, the memory having processor executable instructions stored in the memory that when executed by the processor cause the processor to perform operations comprising:
retrieving and scoring case documents from the electronic media sources via the network by processing on each case document of the case documents from the electronic media sources and storing full text and a single-valued score from each case document in a database;
identifying at least one issue in each of the retrieved case documents according to terms in the retrieved case documents including: weighing each term in each of the retrieved case documents with respect to relevance of the term to each identified issue;
indicating a distribution for identified issues within each of the retrieved case documents; formally associating a list of specific issues with each retrieved case document; ranking the issues relative to each other based on weighted summary metrics; and displaying on a display, the issues ranked in order relative to each other based on the weighted summary metrics.

2. The system of claim 1, where the at least one issue identified in each of the retrieved case documents relates to the date when each of the case documents was retrieved from said electronic media sources.

3. The system of claim 1, the operations further comprising: identifying at least one initial issue in the collection of the retrieved case documents according to terms in the retrieved case documents; and identifying at least one issue in each of the at least one initial issue of the retrieved case documents according to terms in the retrieved case documents for each initial issue.

4. The system of claim 1, the operations further comprising determining a topic-term probability matrix and indicating the distribution for identified issues within each of the retrieved case documents by determining a case document-topic probability matrix.

5. The system of claim 3 the operations further comprising limiting the number of issues formally associated with each of the retrieved case documents based on the values in the case document-topic probability matrix.

6. A non-transitory computer readable storage medium having instructions stored thereon that, when executed by at least one processor cause the at least one processor to perform operations, the operations comprising:
retrieving and scoring case documents from electronic media sources via a communication network by processing on each case document of the case documents from the electronic media sources and storing full text and a single-valued score from each case document in a database;
identifying at least one issue in each of the retrieved case documents according to terms in the retrieved case documents including: weighing each term in each of the retrieved case documents with respect to relevance of the term to each identified issue;
indicating a distribution for identified issues within each of the retrieved case documents; formally associating a limited list of specific issues with each retrieved case document;
ranking the issues relative to each other based on weighted summary metrics; and
displaying on a display, the issues ranked in order relative to each other based on the weighted summary metrics.

7. The medium of claim 6 the operations further comprising: identifying at least one initial issue in the collection of the retrieved case documents according to terms in the retrieved case documents; and identifying at least one issue in each of the at least one initial issue of the retrieved case documents according to terms in the retrieved case documents for each initial issue.

8. The medium of claim 7 the operations further comprising determining a topic-term probability matrix and indicating the distribution for identified issues within each of the retrieved case documents comprises determining a case document-topic probability matrix.

9. The medium of claim 8 the operations further comprising limiting the number of issues formally associated with each of the retrieved case documents based on the values in the case document-topic probability matrix.

10. A method comprising: retrieving and scoring case documents from electronic media sources via a communication network by processing on each case document of the case documents from the electronic media sources and storing full text and a single-valued score from each case document in a database;
identifying at least one issue in each of the retrieved case documents according to terms in the retrieved documents including: weighing each term in each of the retrieved case documents with respect to a relevance of the term to each identified issue;
indicating a distribution for identified issues within each of the retrieved case documents;
ranking the issues relative to each other based on weighted summary metrics; and displaying on a display, the issues ranked in order relative to each other based on the weighted summary metrics.

11. The method of claim 10, further comprising: identifying at least one initial issue in the collection of the retrieved case documents according to terms in the retrieved case documents; and identifying at least one issue in each of the at least one initial issue of the retrieved case documents according to terms in the retrieved case documents for each initial issue.

12. The method of claim 11, further comprising determining a topic-term probability matrix, and indicating the distribution for identified issues within each of the retrieved case documents comprises determining a case document-topic probability matrix.

13. The method of claim 12, further comprising limiting the number of issues formally associated with each of the retrieved case documents based on the values in the case document-topic probability matrix.
